(19) United States
(12) Patent Application Publication
(10) Pub. No.: US 2023/0209689 A1
(43) Pub. Date: Jun. 29, 2023

(54) DMX CONTROL SYSTEM FOR RGB-LED OR WHITE AND WARM WHITE LED LIGHTS

(71) Applicant: JIANGSU LEDCO LIGHTING TECH CO., LTD, Yancheng City (CN)

(72) Inventor: Genhai CHEN, Yancheng City (CN)

(73) Assignee: JIANGSU LEDCO LIGHTING TECHCO., LTD, Yancheng City (CN)

(21) Appl. No.: 17/275,375

(22) PCT Filed: Jun. 1, 2020
(86) PCT No.: PCT/CN2020/093777

§ 371 Date: Jul. 25, 2022

(30) Foreign Application Priority Data
Oct. 30, 2019 (CN) 2019 11043951.6

(51) Int. Cl. H05B 47/18

(52) U.S. Cl. CPC H05B 47/18

(57) ABSTRACT

A DMX control system for RGB-LED or white and warm white LED lights, including: a power input terminal, a DMX control box, RGB-LED or white and warm white LED lights, and an encoder. The encoder is configured to provide signal input for the DMX control box, signal is transmitted between the DMX control boxes and a signal amplifier is connected between the DMX control boxes, a signal amplifier is connected between the DMX control box No. 1-25# and the DMX control box No. 26-50#, and the signal amplifier is configured for amplifying the transmitted signal in real time, so that the number of the DMX control boxes connected reaches 1-N. The DMX control box can provide its own function program for presenting effect of the RGB-LED or white and warm white LED lights; alternatively, 1-N DMX control boxes can be addressed through the encoder, and then connected with a DMX background console, to shield the existing built-in function program of the DMX control box so that any reprogramming program function is demonstrated.

### TECHNICAL YIELD

The disclosure relates to the technical field of lighting control, in particular to a DMX (Digital Multiple X) control system.

### BACKGROUND ART

At present, LED outdoor lighting products are widely used in engineering and commerce. In most cases, the same product presents in a relatively single form, which can only be controlled in a single way and cannot meet the increasingly strong and high demand of customers.

### SUMMARY

### Technical Problem

An object of the present disclosure is to provide a DMX control system for RGB-LED or white and warm white LED lights, so as to solve the technical problem that synchronization and lighting control cannot be achieved between lamps at different locations or distance.

### SOLUTION TO THE PROBLEM

### Technical Solution

In order to achieve the above objective, the technical solution of the present disclosure is as follows:

A DMX control system for RGB-LED or while and warm white LED lights, is provided, including: a power input terminal, a DMX control box, RGB-LED or white and warm white LED lights, and an encoder. The encoder is configured to provide signal input for the DMX control box, signal is transmitted between the DMX control boxes and a signal amplifier is connected between the DMX control box No. 1-25# and the DMX control box No. 26-50#, the signal amplifier is configured for amplifying the transmitted signal in real time, so that the number of the DMX control boxes connected reaches 1-N.

In the above technical solution, the DMX control system includes a power supply input circuit and a power supply conversion circuit, terminal 1 of the power supply input circuit is connected with a micro fuse F1 which is an electrical element for ensuring the safe operation of the circuit. A varistor mov1 is connected in parallel between the terminal 1 and a terminal 2 of the power supply input circuit, by which the voltage can be clamped to a relatively fixed voltage value, realizing protection for the subsequent circuit. A capacitor C15 is connected in parallel between the terminal 1 and the terminal 2 of the circuit, an I-shaped inductor L2 is connected in series with the terminal 1 of the circuit, and a thermistor R7 is connected in series with the terminal 2 of the circuit (the thermistor R7 connected in series in the power supply circuit can effectively suppress the start-up surge current and is used to convert the power supply after the suppression of the surge current is completed). The terminals 1 and 2 of the input circuit are connected to input terminals 1 and 2 of an inductor L4 respectively, and output terminals 3 and 4 of the inductor L4 are connected to input terminals 1 and 2 of a rectifier bridge G1 respectively to convert AC into DC, and a capacitor C3 (which is configured for filtering and suppressing clutter and spike currents in the circuit to make the filtered DC current more straight and reach the ideal DC power supply), a polarity capacitor C4 (in the circuit, it is distinguished between positive electrode and negative electrode, where a bar represents positive electrode while an arc represents negative electrode, which is applied in the DC circuit) and a resistor R2 are connected in parallel between the DC terminals 3 and 4 of the rectifier bridge G1. Terminal N of the circuit is connected to a digital ground, and terminal L of the circuit is connected to a DC power supply of 310V.

In the above solution, the encoder is powered with a voltage of 5-24V. The output of the encoder is connected to DC input J3 of the DMX control box. D+ is a DC positive electrode, D− is a DC negative electrode and GND is a ground terminal. A signal input is encoded by ADI, forming an output from DC output J4 of the DMX control box which is connected an input of an adjacent DMX control box.

In the above solution, a signal amplifier is connected between the DMX control box No. 1-25# and the DMX control box No. 26-50#, and the signal amplifier is configured for amplifying the transmitted signal in real time, so that the number of the DMX control boxes connected reaches 1-N.

In the above solution, the DMX control box has an input of 24-230V which is converted to 310V to be output, at a DC output terminal for powering the RGB-LED or white and warm white LED lights. The DMX control box receives a signal DC input from the encoder. D+ is the DC positive electrode, D− is the DC negative electrode, and GND is a ground terminal. A signal input is encoded by ADI, forming an output from the DC output of the DMX control box.

In the above solution, a single DMX control box can connect up to 1500 LEDs with protection index of IP44, operating temperature of 0-70 degrees, input voltage of 24-230V, output voltage of 310V, and output current of 1 A. The blue wire is connected to D+, the black wire is connected to D−, the green wire is connected to the current ground, and the brown wire is connected to the encoder signal line.

In the above solution, the DMX control box is capable of presenting effect of RGB-LED or white and warm white LED lights through its own functional program.

In the above solution, the DMX control box first encodes 1-N addresses for the DMX control boxes through the encoder, and then connects with a DMX background console, to shield the existing built-in function program of the DMX control box so that any reprogramming program function is demonstrated.

In the above solution, for the DMX control system for RGB-LED or white and warm white LED lights, the DMX control conversion between different products can be achieved by only changing a SD program function card of the encoder.

In the above solution, the DMX control box first encodes 1-N addresses for the DMX control boxes through the encoder, and the SD program function card of the encoder performs a function validation on the RGB-LED or white and warm white LED lights controlled by the DMX control boxes; if the validation is successful, the lights present a function of the SD program function card of the encoder, if the validation shows an error, the RGB-LED or white and warm white LED lights controlled by the DMX control box present a built-in function in the DMX control box.

In the above solution, the DMX control box is connected with a DMX background console, to shield the existing built-in function program of the DMX control box so that any reprogramming program function is demonstrated; if the validation is successful, the lights present any program function that is re-programmed, if the validation shows an error, the RGB-LED or white and warm white LED lights controlled by the DMX control box present a built-in function in the DMX control box.

In the above solution, the encoder is capable of achieving 1-N addresses.

### BENEFICIAL EFFECTS OF THE INVENTION

### Beneficial Effect

The above technical solution adopted by the present disclosure has the technical effects as follows.

By the DMX control system for RGB-LED or white and warm white LED lights according to embodiments of the present disclosure, the DMX control box can provide its own function program for presenting effect of the RGB-LED or white and warm white LED lights; alternatively, 1-N DMX control boxes can be addressed through the encoder, and then connected with a DMX background console, to shield the existing built-in function program of the DMX control box so that any reprogramming program function is demonstrated.

### BRIEF DESCRIPTION OF THE DRAWINGS

### Description of Drawings

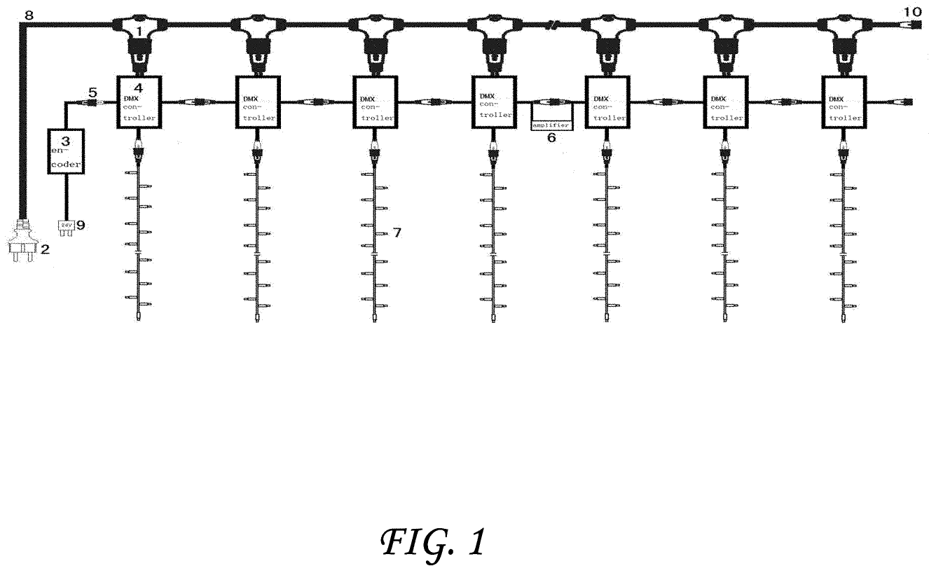

FIG. 1 is an overall product diagram of a DMX control system for RGB-LED or white and warm white LED lights according to the present disclosure;

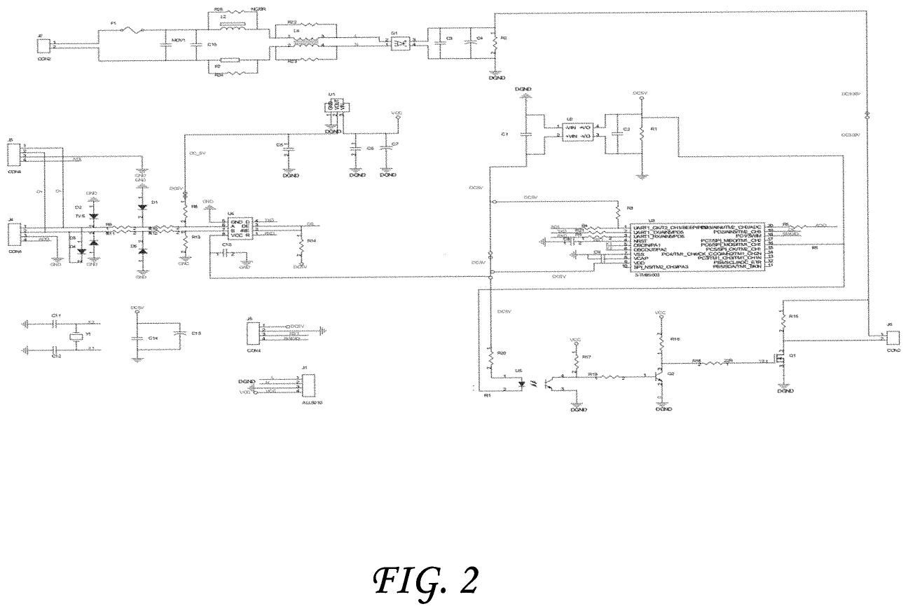

FIG. 2 is a circuit diagram of a DMX control box of the DMX control system for RGB-LED or white and warm white LED lights according to the present disclosure;

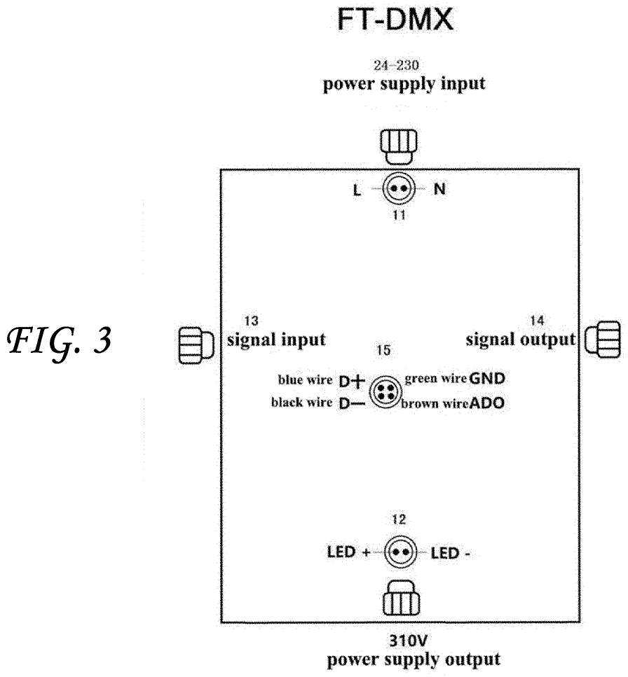

FIG. 3 is a schematic diagram showing connections of the DMX control box of the DMX control system for RGB-LED or white and warm white LED lights according to the present disclosure;

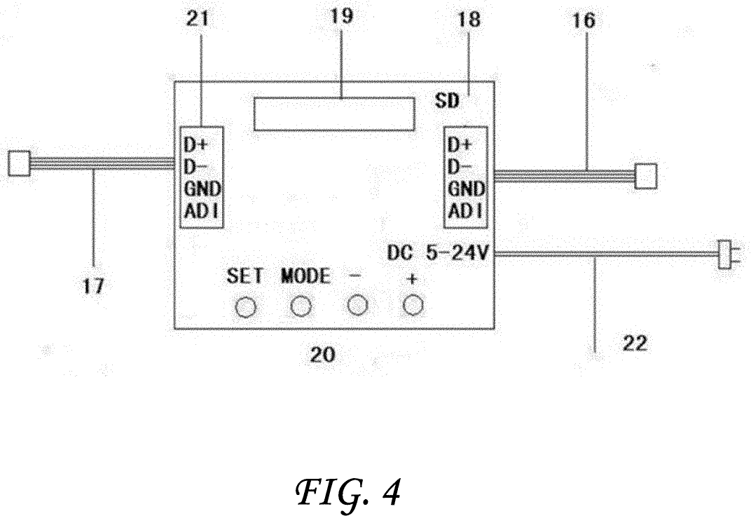

FIG. 4 is a schematic diagram of an encoder of the DMX control system for RGB-LED or white and warm white LED lights according to the present disclosure;

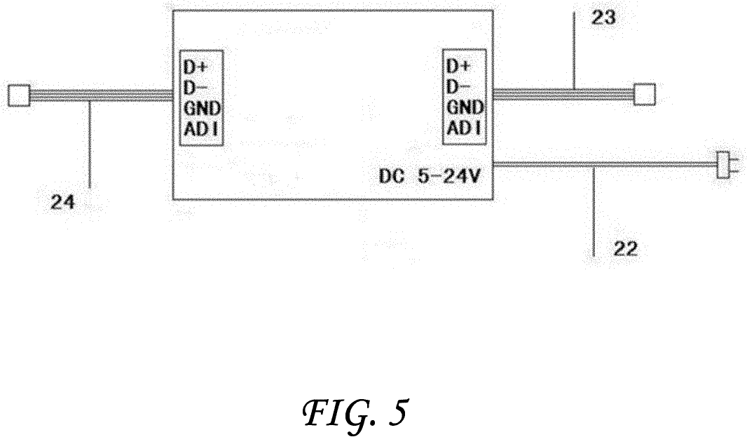

FIG. 5 is a schematic diagram of a signal amplifier of the DMX control system for RGB-LED or white and warm white LED lights according to the present disclosure.

List of reference numerals:
1 lamp holder;
2 power supply plug;
3 encoder;
4 DMX control box;
5 connector;
6 amplifier;
7 load lights;
8 conductor;
9 5-24V plug;
10 tail plug;
11 input of DMX control box;
12 output of DMX control box;
13 signal input of DMX control box;
14 signal output of DMX control box;
15 DMX signal line connection;
16 encoder input;
17 encoder output;
18 encoder SD card;
19 encoder display board;
20 encoder keys;
21 encoder signal line;
22 5-24V input;
23 signal input of signal amplifier;
24 signal output of signal amplifier.

### THE EMBODIMENT OF THE INVENTION

### Detailed Description of the Embodiments

The following describes the technical solutions of the present disclosure in further detail with reference to the accompanying drawings.

As shown in FIG. 1 which is an overall product diagram of a DMX control system for RGB-LED or white and warm white LED lights, a power supply of 24-220V is connected via a plug 2 and a conductor 8 to a lamp holder 1 of the product and thus a DMX control box 4. The DMX control box 4 is connected to the RGB-LED or white and warm white LED lights, i.e., load lights 7. The whole circuit is switched on. All connections of the product are done through a connector 5, and a tail plug 10 is provided at the end of the product.

As shown in FIG. 1, the built-in functions of the DMX control box 4 are as follows.

1. RGB built-in function: Switching a color every 15 s: steady; switching a color every 15 s: steady+white flashing;

Switching a color every 15 s: fade-in and fade-out; switching a color every 15 s: alternative on and off; switching a color every 15 s: full flashing; each function lasts 15 s. The order of color change is: red/green/yellow/blue/white/purple/all colors/light blue.

2. White and warm white built-in function: (White/warm white/light warm white) steady color, switching a color every 15 s; (white+white flashing/warm white+warm white flashing/white+warm white flashing/warm white+white flashing), switching a color every 15 s; (white/warm white/light warm white) fade-in and fade-out for 8 s, switching to next color after fade-in and fade-out twice for a color; (white/warm white/light warm white) alternative on and off, switching to next color after flashing for 15 s; (white flashing/warm white flashing), changing a color every 15 s.

As shown in FIG. 1, a power supply 9 of 5-24V is connected via the conductor 8 to the encoder 3, which is connected to the DMX control box 4 via a signal line. The encoder encodes addresses 1-N for the DMX control boxes. The SD program function card of the encoder performs function validation for the RGB-LED or white and warm white LED lights controlled by the DMX control box, and presents the function of the SD program function card of the encoder if the validation is successful.

3. The SD functions of RGB color are as follows: Steady function: The lights are always on and emit light of red, green, pink, yellow, blue, light green color, all colors and white color, switching a color every 15 s. The color of the emitted light is controlled by the DMX control box. Reciprocating function: The lights are turned on in order and emit light of all colors, then only red, green, pink, yellow, blue, light green, white color and so on, switching a color every 15 s. Flashing function: The lights, sequentially one group by one group, are flashing with the other groups on. The lights emit light of red, then green, pink, yellow, blue, light green, white color and so on, switching a color every 15 s. The frequency of flashing can be increased or decreased. Running function 1: When all lights emit light of red, the middle group of LED changes to white and the lights adjacent thereto sequentially changes to white, as if the white color were running, and then all the lights are green, pink, yellow, blue, light green, white color and so on, switching a color every 15 s. Running function 2: The lights, divided into groups, sequentially one group by one group, are turned on and then off, i.e., as if the colors were running. The lights emit light of red, then green, pink, yellow, blue, light green, white color and so on, switching a color every 15 s.

4. The SD functions of white and warm white color are as follows: Steady function: The lights are always on and emit light of white, warm white and light warm white color, switching a color every 15 s. The color of the emitted light is controlled by the DMX control box. Reciprocating function: The lights are turned on in order and emit light of white color, then only white, warm white and light warm white color and so on, switching a color every 15 s. Flashing function: The lights, sequentially one group by one group, are flashing with the other groups on. The lights emit light of white, warm white and light warm white color and so on, switching a color every 15 s. Running function: The lights, divided into groups, sequentially one group by one group, are turned on and then off, i.e., as if the colors were running The lights emit light of white, warm white and light warm white color and so on, switching a color every 5 s.

As shown in FIG. 2 which is a circuit diagram of the DMX control box, terminal 1 of the power supply input circuit is connected with a micro fuse F1 which is an electrical element for ensuring the safe operation of the circuit. A varistor mov1 is connected in parallel between the terminal 1 and a terminal 2 of the power supply input circuit, by which the voltage can be clamped to a relatively fixed voltage value, realizing protection for the subsequent circuit. A capacitor C15 is connected in parallel between the terminal 1 and the terminal 2 of the circuit, an I-shaped inductor L2 is connected in series with the terminal 1 of the circuit, and a thermistor R7 is connected in series with the terminal 2 of the circuit (the thermistor R7 connected in series in the power supply circuit can effectively suppress the start-up surge current and is used to convert the power supply after the suppression of the surge current is completed). The terminals 1 and 2 of the input circuit are connected to input terminals 1 and 2 of an inductor L4 respectively, and output terminals 3 and 4 of the inductor L4 are connected to input terminals 1 and 2 of rectifier bridge G1 respectively to convert AC into DC, and a capacitor C3 (which is configured for filtering and suppressing clutter and spike currents in the circuit to make the filtered DC current more straight and reach the ideal DC power supply), a polarity capacitor C4 (in the circuit, it is distinguished between positive electrode and negative electrode, where a bar represents positive electrode while an arc represents negative electrode, which is applied in the DC circuit) and a resistor R2 are connected in parallel between the DC terminals 3 and 4 of the rectifier bridge G1. Terminal N of the circuit is connected to a digital ground, and terminal L of the circuit is connected to a DC power supply of 310V.

As shown in FIG. 2, connections of the master integrated circuit microcontroller U3 are as follows. The encoder is connected to DC input J3 of the DMX control box. D+ is a DC positive electrode, D− is a DC negative electrode and GND is a ground terminal. A signal input is encoded by ADI, forming an output from DC output J4 of the DMX control box. Terminals D+, D− of J4 of the DMX control box are connected in series or in parallel to transient diodes D2\D3\D4 to effectively protect precision components in the electronics from various surge pulses. The other end of the transient diodes D2\D4 is connected to a ground terminal. Terminal D+ of J4 of the DMX control box is connected to resistors R9 and R10 in series, while terminal D− of the DMX control box is connected to resistors R11 and R12 in series. Electrostatic suppression diodes D1\D5 are connected between the resistors, mainly to prevent the presence of electrostatic in the circuit. Terminal D− of J4 of the DMX control box is connected in parallel to resistor R13 and then grounded, and terminal D+ of J4 of the DMX control box is connected in parallel to resistor R8 to output a voltage of DC 5V. Terminals D− and D+ of J4 of the DMX control box are connected with terminals 7, 6 of line communication chip U4 and thus to the input/output bus interface. U4 is provided with terminal 5 connected to terminal GND, wherein terminal 1 which is R: receiver input terminal, terminal 2 which is RE: receiver enable terminal, and terminal 3 which is DE: driver enable terminal. Terminals 2 and 3 of U4 are connected to resistor R14 and then grounded. U4 is further provided with terminal 4 which is D: driver output end, and is provided with terminal 8 which is connected to VCC (a power supply of 5V) outputting a voltage of DC 5V.

Terminal 8 of U4 (DC 5V) is connected to pin 2 (DC5V) of DC/DC power module U2 which is a 1 W single-output DC/DC power module. It is specially designed for the power supply in the distributed power supply system on PCB that needs to be isolated with the input power supply and has a high requirement for output accuracy. Pins 1, 2 of U2 is connected in parallel to capacitor C1 at an input terminal and then to the digital ground terminal in the DGND digital circuit, and pins 3, 4 of U2 is connected in parallel to C2, R1, and then output DC 5V at one end and grounded at the other end.

Terminal 6 (DC 5V) of U4 is connected to an input terminal VOUT of forward low-voltage-drop regulator U1. GND of U1 is a ground terminal, the input terminal VIN of forward low-voltage-drop regulator U1 is connected in parallel to coupling capacitor C6 and electrolytic capacitor C7, and then to the digital ground terminal in the DGND digital circuit at one end and to the power supply VCC at the other end.

Pins 3, 4 of DC/DC power module U2 are connected in parallel to C2, R1 and then to DC 5V at one end, which have a MOSI (master in slave out) connection with terminal 16 (SPI) of integrated circuit microcontroller U3-MCU. The integrated circuit microcontroller U3-MCU is provided with terminal 1 (PD4) which is timer channel 2/buzzer output/clock USRT1, terminal 2 (PD5) which is configured for data reception from analog input 5, terminal 3 (PD6) which is configured for data reception from analog input 6, terminal 4 (NRST) which is a reset terminal, terminal 7 (VSS) which is a ground terminal for digital part, terminal 8 (VCAP) which is a 1.8V regulator capacitor, terminal 9 (VDD) which is a digital power supply DC 5V, terminal 20 which is timer channel 2 for analog input 4/ADC external triggering, terminal 16 (SPI) which is MOSI (master in slave out), and terminal 18 (SWIM) which is a data interface.

Terminal 9 (VDD) of the integrated circuit microcontroller U3-MCU is a power supply of DC 5V, which is interconnected with terminal 2 (DC5V) of photoelectric coupler U5, terminal 8 (DCSV) of U4, and terminals 1, 2 (DCSV) of DC/DC power module U2. Terminal 6 (DC5V) of U4 is connected with the input terminal VOUT of the forward low-voltage-drop regulator U1, forming a power supply of DC 5V for the circuit.

Terminal 2 (cathode) of the photoelectric coupler U5 is connected to resistor R1 of the power supply module U2. Terminals 1, 2 of U5 are input terminals, terminal 3 (transmitter) of U5 is connected to DGND, terminal 4 (collector) of U5 is connected with components R17, R19, Q2, R16, and then to transistor Q1. Terminal 2 of the transistor Q1 is the source (S), which is connected to J6, and then DC 320V.

Y1 is a crystal oscillator. 12MH crystal oscillator is a quartz crystal oscillator capable of periodically generating a repetitive signal. The most important characteristic of a quartz crystal oscillator is its frequency, i.e. oscillation per unit time. Y1 is connected to C11 and C12 at both ends and is grounded.

Terminals 2, 3 of the line communication chip U4 are connected with resistor R14 and then connected to terminal 19 (DE) of the integrated circuit microcontroller U3-MCU. Terminal 2(TXD) of U3-MCU is connected with terminal 4 (TXD) of the line communication chip U4, terminal 3 (RXD) of U3-MCU is connected with terminal 1 (RXD) of the line communication chip U4, terminal 1 (ADI) of U3-MCU is connected with terminal 4 (ADI) of J3, i.e., coding signal input, terminal 20 (ADO) of U3-MCU is connected with terminal 4 (ADO) of J4, and terminal 18 (SWDIO) of U3-MCU is connected with terminal 4 (SWDIO) of J5.

As shown in FIG. 2, DGND is a digital ground in the digital circuit, and all DGND points in the circuit diagram are connected by one point, that is, all analog AGNDs and digital DGNDs are connected in advance and then are connected at only one point, but not all the grounds are connected together. GND is a common ground (i.e., the negative terminal of the power supply). VCC represents the positive electrode (+), each VCC point is interconnected with one another.

Referring to FIG. 3, which is a schematic diagram showing connections of the DMX control box. An input 11 of the DMX control box 4 is converted into an output 12 of the DMX control box through a circuit of a circuit board. A signal input 13 of the DMX control box is converted into a signal output 14 of the DMX control box through a circuit of the circuit board. Reference numeral 15 denotes DMX signal line connection.

As shown in FIG. 4, the encoder 3 is powered by a power supply 22 (5-24V), input 16 is converted into encoder output 17 by an encoder circuit, reference numeral 18 denotes an encoder SD card, reference numeral 19 denotes an encoder display board, and reference numeral 20 denotes an encoder key; reference numeral 21 denotes an encoder signal line. Before the first encoding, an SD card with a DMX file is inserted into an encoder once, and the encoder reads parameters. Addressing operation: the debug key MODE is pressed to switch to C, C05 is selected so as to select an encoding type. The debug key MODE is pressed again to select P (P indicates the number of points for each chip strap), keys“+”, “−” may be pressed to select the number of points, and P01 is selected normally. The debug key MODE is pressed to select N so as to select the number of channels for the lights, and N01 is selected normally. The debug key MODE is pressed to select E, and E01 is selected, then addressing starts once the confirmation key SET is pressed.

As shown in FIG. 5, a signal amplifier 6 is powered by a power supply 22 (5-24V). DMX control box 25# is connected to a signal input terminal 23 of the signal amplifier 6, forming an output from a signal output terminal 24 of the signal amplifier 6 through an amplifier circuit which is connected to DMX control box 26#. Therefore, the transmission signal is amplified in real time, and the number of the DMX control boxes connected reaches 1-N.

The objectives, technical solutions and beneficial effects of the present disclosure are described in further detail through the specific embodiments above. It should be understood that the above description is only specific embodiments of the present disclosure and are not intended to limit the protection scope of the present disclosure. Any modification, equivalent replacement, improvement, etc. made within the spirit and principle of the present disclosure should be included in the protection scope of the present disclosure.

1. A DMX control system for RGB-LED or white and warm white LED lights, comprising: a power input terminal,
a DMX control box,
RGB-LED or white and warm white LED lights, and
an encoder,
wherein the encoder is configured to provide signal input for the DMX control box, signal is transmitted between the DMX control boxes and a signal amplifier is connected between the DMX control boxes, the signal amplifier is configured for amplifying the transmitted signal in real time, so that the number of the DMX control boxes connected reaches 1-N.

2. The DMX control system for RGB-LED or white and warm white LED lights of claim 1, wherein the DMX control box is capable of presenting effect of RGB-LED or white and warm white LED lights through its own functional program, or 1-N DMX control boxes are addressed through the encoder, and then connected with a DMX background console, to shield the existing built-in function program of the DMX control box and realize a reprogramming function.

3. The DMX control system for RGB-LED or white and warm white LED lights of claim 2, wherein the DMX control box has an input of 24-230V which is converted to 310V to be output.

4. The DMX control system for RGB-LED or white and warm white LED lights of claim 3, wherein the signal amplifier is connected between the DMX control box No. 1-25# and the DMX control box No. 26-50#, and the signal amplifier is configured for amplifying the transmitted signal in real time, so that the number of the DMX control boxes connected reaches 1-N.

5. The DMX control system for RGB-LED or white and warm white LED lights of claim 4, wherein DMX control conversion between different products can be achieved by only changing a SD program function card of the encoder.

6. The DMX control system for RGB-LED or white and warm white LED lights of claim 1, wherein the DMX control box first encodes 1-N addresses for the DMX control boxes through the encoder, and the SD program function card of the encoder performs a function validation on the RGB-LED or white and warm white LED lights controlled by the DMX control boxes; if the validation is successful, the lights present a function of the SD program function card of the encoder, if the validation shows an error, the RGB-LED or white and warm white LED lights controlled by the DMX control box present a built-in function in the DMX control box.

7. The DMX control system for RGB-LED or white and warm white LED lights of claim 1, wherein the DMX control box is connected with a DMX background console, to shield the existing built-in function program of the DMX control box and realize a reprogramming function; if the validation is successful, the lights present any program function that is re-programmed, if the validation shows an error, the RGB-LED or white and warm white LED lights controlled by the DMX control box present a built-in function in the DMX control box.

8. The DMX control system for RGB-LED or white and warm white LED lights of claim 1, wherein the encoder is capable of achieving 1-N addresses.
